(19) United States
(12) Patent Application Publication
(10) Pub. No.: US 2013/0222388 A1
(43) Pub. Date: Aug. 29, 2013

(54) METHOD OF GRAPH PROCESSING

(71) Applicant: Callum David McDonald, Sunnybank (AU)

(72) Inventor: Callum David McDonald, Sunnybank (AU)

(21) Appl. No.: 13/774,297

(22) Filed: Feb. 22, 2013

(30) Foreign Application Priority Data
Feb. 24, 2012 (AU) 2012900709

(51) Int. Cl. G06T 11/20

(52) U.S. Cl. CPC G06T 11/206
USPC 345/440

(57) ABSTRACT

A method of compressing a graph representation, and method of solving a problem represented by a graph using graph compression enable improved data searching techniques. The graph representation includes a plurality of vertices and a plurality of edges. A first clustered graph is generated by clustering the plurality of vertices of the graph representation. Each cluster of vertices is then replaced by a clustered vertex, wherein the clustered vertex inherits edges from the vertices of the cluster. Superfluous edges of the first clustered graph are then removed. A traversal probability for each of the removed edges is determined, and one or more of the edges that have been removed is selected for embedding in the first clustered graph, based upon a traversal probability for each of the edges. Information relating to the one or more edges is then embedded into the first clustered graph.

### FIELD OF THE INVENTION

The present invention relates to graph processing. In particular, although not exclusively, the invention relates to graph compression.

### BACKGROUND TO THE INVENTION

With the expansion of the World Wide Web and the advent of modern databases, the need to store and process very large amounts of data has become increasingly important. There are often relationships between the data, and graphs are often used to represent these relationships.

The main principles currently used to rank documents on the Internet are based on relationships between documents, which is particularly suited to graph theory. There are, however, often very stringent time restrictions placed on database systems to produce results quickly rather than optimally.

Ranking documents using graph theory includes generation of a graph which is then processed in order to evaluate the utility of each vertex of the graph in relation to a given query.

Much of the early work done in relation to ranking a set of documents falls into the category of static ranking and is used in algorithms such as PageRank. Static ranking models the behavior of a user that has no knowledge of the query. Such users are herein referred to as undirected users. This kind of ranking has both benefits and disadvantages. The main benefit stems from the fact that all calculation can be done offline, thus avoiding the time penalty that would otherwise result when processing the query online.

A disadvantage of static ranking is that it is simply not possible to accurately predict the behavior of a user, as the goals of the user relating to their information requirement is not known.

Attempts have been made to overcome these disadvantages by modeling directed users. A directed user differs from an undirected user in that underlying prior knowledge about the query is incorporated into the model. A directed user, unlike an undirected user, will change their behavior in order to optimize their own utility with respect to a given query.

Disadvantages of models that involve directed users include that the inherently dynamic nature of directed users requires an online solution, and that the modeling of a directed user is time consuming when processing a query.

Current ranking algorithms that try to emulate directed users do so in a suboptimal way due to processing restrictions. This includes placing a limit on the number of vertices examined in the graph or relying on a set of heuristics to assess the relevance of documents to a given query.

The Hilltop algorithm (Bharat & Mihaila 1999) includes a directed user model and is based on the notion of experts. An expert document is a document that has a strong match to the query terms supplied by the user, and the relationship between the expert document and the target document is used to rank the target document

ExpertRank (Jiao, Yan, Zhao & Fan, 2009) is an algorithm similar to the Hilltop algorithm but also attempts to build a network of links to rank documents. The procedure of linking documents together is accomplished by progressively expanding the set of documents that are linked to or by the current set of expert documents.

Both the Hilltop and ExpertRank algorithms try to calculate a reward in relation to the query dynamically, and are therefore limited in their processing of a query. They therefore do not include all information known during query processing, and due to the time restrictions discussed above only the top documents are taken and ranked using a more sophisticated algorithm.

Another limitation of the above approaches is the limited granularity at which content is described. Due to time restrictions, current techniques used to rank documents typically involve building a network of links generated at the document level to describe relationships between individual documents rather than using keywords.

If additional keywords are used to rank a document, they are typically pre-generated with respect to a given query term. These pre-generated keywords are then usually statically supplemented into the set of query terms during query processing to identify documents with higher than average relevance. A disadvantage of this approach is that only a limited number of relevant keywords can be pre-generated due to processing constraints.

There is therefore a need for improved graph compression and processing.

### SUMMARY OF THE INVENTION

It is an object of some embodiments of the present invention to provide consumers with improvements and advantages over the above described prior art, and/or overcome and alleviate one or more of the above described disadvantages of the prior art, and/or provide a useful commercial choice.

According to one aspect, the invention provides a method of compressing a graph representation, the graph representation including a plurality of vertices and a plurality of edges, the method including:
generating, by a computer processor, a first clustered graph by clustering the plurality of vertices of the graph representation, replacing each cluster of vertices with a clustered vertex, wherein the clustered vertex inherits edges from the vertices of the cluster, and removing superfluous edges of the first clustered graph;
determining, by the computer processor, a traversal probability for each of the edges that have been removed from the graph representation;
selecting, by the computer processor, one or more of the edges that have been removed for embedding in the first clustered graph, based upon the traversal probability for each of the edges; and
embedding, by the computer processor, information relating to the one or more edges into the first clustered graph.

Preferably, the superfluous edges comprise edges that either join vertices of a single cluster or are duplicate edges joining a common pair of clustered vertices.

Preferably, the vertices of the graph representation each correspond to a document. Alternatively, the vertices of the graph representation each correspond to an image file, an audio file and/or a video file. Alternatively again, the vertices of the graph each correspond to a file or a part of a file.

Preferably, the clustering is performed based at least partly upon traversal probabilities between the plurality of vertices. Alternatively or additionally, the traversal probabilities are determined according to a number of matching keywords between two documents.

Preferably, the traversal probabilities are determined by estimating a limiting distribution of the graph.

Preferably, the edges that are selected for embedding in the first clustered graph are selected by having the highest traversal probability.

Preferably, embedding information of the one or more edges into the first clustered graph comprises generating a metadata file associated with the first clustered graph.

Preferably, the method further includes:
generating, by a computer processor, a second clustered graph by clustering the clustered vertices of the first clustered graph, replacing each cluster of clustered vertices with a further clustered vertex, wherein the further cluster vertex inherits edges from the clustered vertices of the cluster, and removing superfluous edges of the second clustered graph;
determining, by the computer processor, a traversal probability for each of the edges that have been removed from the first clustered graph;
selecting, by the computer processor, one or more of the edges that have been removed from the first clustered graph for embedding in the second clustered graph, based upon the traversal probability for each of the edges; and
embedding, by the computer processor, information relating to the one or more edges into the second clustered graph.

Preferably, the method further includes:
selecting, by the computer processor, one or more of the edges that have been removed from the first clustered graph for embedding in the first clustered graph, based upon the traversal probability for each of the edges; and
embedding, by the computer processor, information relating to the one or more edges into the first clustered graph.

Preferably, the method further includes:
generating, by the computer processor, a set of keywords for each document of the graph representation;
generating, by the computer processor, a first plurality of edges between documents of the graph representation, wherein each edge of the first plurality of edges is between two documents that include similar keyword sets; and
generating, by the computer processor, a second plurality of edges between documents of the plurality of documents, wherein each edge of the second plurality of edges is between a first and second document, wherein the first document includes a link to the second document.

According to a second aspect, the invention resides in a method of solving a problem associated with a graph representation, the graph representation including a plurality of vertices and a plurality of edges, the method including:
generating, by a computer processor, a first clustered graph by clustering the plurality of vertices of the graph representation, replacing each cluster of vertices with a clustered vertex, wherein the clustered vertex inherits edges from the vertices of the cluster, and removing edges that either join vertices of a single cluster or are duplicate edges joining the same clustered vertex, the first clustered graph defining a first approximation of the problem;
determining, by the computer processor, a traversal probability for each of the edges that have been removed from the graph representation;
selecting, by the computer processor, one or more of the edges that have been removed for embedding in the first clustered graph, based upon the traversal probability for each of the edges; and
embedding, by the computer processor, information relating to the one or more edges into the first clustered graph;
determining a solution to the first approximation of the problem using the first clustered graph;
expanding at least one clustered vertex into a corresponding cluster of vertices to generate a second clustered graph, the second clustered graph defining a second approximation of the problem; and
determining a solution to the second approximation of the problem using the second clustered graph.

According to a third aspect, the invention resides in a method of solving a problem associated with a graph representation including:
generating, by a computer processor, a first clustered graph, the first clustered graph representing an approximation of the problem;
determining, by the computer processor, a solution corresponding to the first approximation of the problem using the first clustered graph;
selecting, by the computer processor, a clustered vertex that appears to have a high influence on the optimization problem;
expanding, by the processor, the selected clustered vertex into a corresponding cluster of vertices to generate a second clustered graph, the second clustered graph representing a second approximation of the problem; and
determining, by the processor, a solution to the second approximation of the problem using the second clustered graph and the solution to the first approximation of the problem.

### BRIEF DESCRIPTION OF THE DRAWINGS

To assist in understanding the invention and to enable a person skilled in the art to put the invention into practical effect, preferred embodiments of the invention are described below by way of example only with reference to the accompanying drawings, in which:

FIG. 1 illustrates a method of compressing a graph representation, according to an embodiment of the present invention;

FIG. 2a and FIG. 2b illustrate an example of clustering and merging vertices, according to the method of FIG. 1;

FIG. 3 illustrates a method of selecting edges for embedding in the graph representation, according to an embodiment of the present invention;

FIG. 4a and FIG. 4b illustrate an example of selecting edges for embedding in the graph representation, according to the method of FIG. 3;

FIG. 5 illustrates a hierarchy including storage of keywords, according to an embodiment of the present invention;

FIG. 6 illustrates a method of building a graph, according to an embodiment of the present invention;

FIG. 7 diagrammatically illustrates a server, according to an embodiment of the present invention;

FIG. 8a and FIG. 8b illustrate an example of processing a search query, according to an embodiment of the present invention; and

FIG. 9 illustrates a method of solving a problem according to an embodiment of the present invention.

Those skilled in the art will appreciate that minor deviations from the layout of components as illustrated in the drawings will not detract from the proper functioning of the disclosed embodiments of the present invention.

### DETAILED DESCRIPTION OF THE PREFERRED EMBODIMENT(S)

Embodiments of the present invention comprise systems and methods for compressing a graph representation. Elements of the invention are illustrated in concise outline form in the drawings, showing only those specific details that are necessary to the understanding of the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

According to one aspect, the invention provides a method of compressing a graph representation, the graph representation including a plurality of vertices and a plurality of edges, the method including: generating, by a computer processor, a first clustered graph by clustering the plurality of vertices of the graph representation, replacing each cluster of vertices with a clustered vertex, wherein the clustered vertex inherits edges from the vertices of the cluster, and removing superfluous edges of the first clustered graph; determining, by the computer processor, a traversal probability for each of the edges that have been removed from the graph representation; selecting, by the computer processor, one or more of the edges that have been removed for embedding in the first clustered graph, based upon the traversal probability for each of the edges; and embedding, by the computer processor, information relating to the one or more edges into the first clustered graph.

Advantages of some embodiments of the present invention include an ability to build a compressed graph encompassing the vertices of interest while excluding vertices that have little or no value. It is therefore possible to apply standard hierarchical searching techniques to explore only regions of high utility when expanding the compressed graph and avoiding regions of low utility. A further advantage is that the amount of data that needs to be transferred from external storage, for example, in order to execute the query is reduced.

Additionally, according to certain embodiments, it is possible to include all available information when processing the query. That is, there is no significant additional cost incurred by including all query matches when ranking documents.

According to certain embodiments, the present invention uses varying levels of granularity to describe a large graph at different levels of detail. This enables the most important dimensions of a graph to be captured at the coarse levels of granularity through prioritization of edges based on traversal probabilities. The reduced representation of the graph, i.e. the coarse levels of granularity, can be used to approximate the transition probabilities between a subset of nodes in the graph. In addition to storing edges at every vertex in the graph, other information can also be stored such as a set of relevant keywords.

Additionally, embodiments of the present invention allow for more intelligent searching of a database by grouping vertices that share strong relationships with each other.

Although described mainly in the context of search engines, the present invention is applicable in numerous applications, particularly in the area of databases, but also more generically. For instance, the present invention can be used in relation to estimating associations between different locations on a map by finding the set of closest vertices which are of interest to the user. Significantly, this data structure could be used in any situation where a large graph needs to be processed quickly, when only considering a subset of the vertices.

Furthermore, the present invention is applicable to more general problem solving and optimization problems. In particular, various different optimization problems can be represented as a graph, which can then be optimized or solved utilizing the present invention. In this case, the problem can be solved iteratively using graph compression of the present invention. This enables a problem to be solved according to a desired level of granularity.

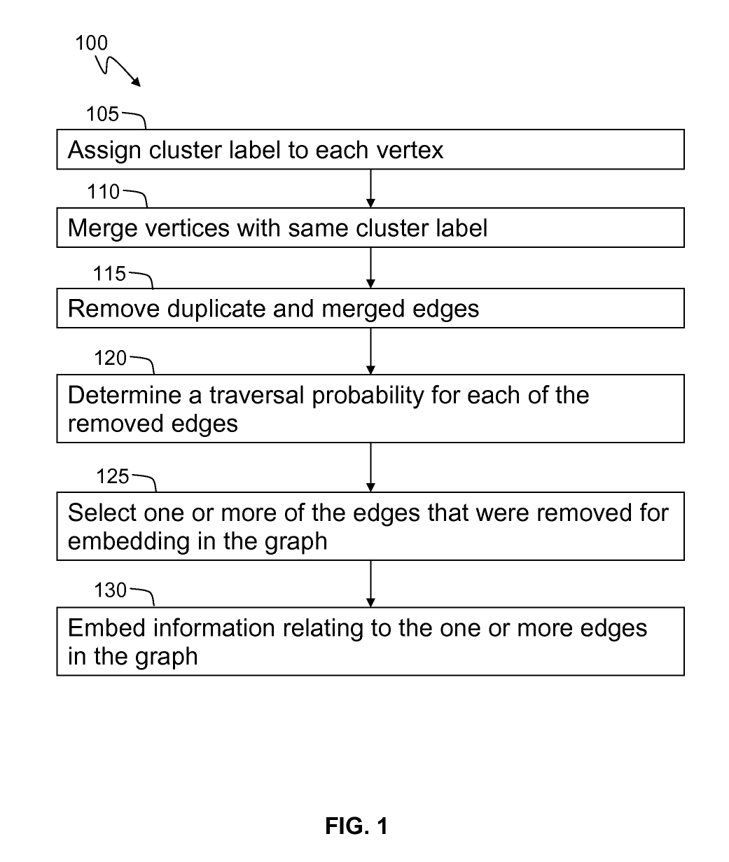

FIG. 1 illustrates a method 100 of compressing a graph representation, according to an embodiment of the present invention. In step 105, each vertex of the graph representation is assigned, by a computer processor, a cluster value. There are a large number of clustering algorithms of the prior art that are suitable for clustering vertices of a graph, and the present application is not restricted to a particular method. Clustering algorithms that seek to implement a minimum edge cut approach, where edges with high traversal probability are merged first, are preferred. When the sum of outgoing edge weights for all vertices is minimal, the traversal probabilities between different vertices are better approximated at varying levels of compression.

In step 110, vertices of the graph representation that are assigned common cluster values are merged, by the computer processor. This is performed by replacing the original vertices with merged vertices, wherein each merged vertex of the merged vertices corresponds to a single cluster value.

In step 115, superfluous edges of the graph are removed. In this case, the superfluous edges comprise edges in the graph representation that either join vertices that are now part of a single merged vertex, or are duplicate edges joining the same merged vertices, are removed by the computer processor. Step 115 can be performed in parallel to or in combination with step 110. Duplicate edges are preferably replaced by a new edge.

In step 120, a traversal probability for each of the edges that are removed is determined by the computer processor. The probability of transitioning from one vertex to the next can be approximated with the transition probability at time infinity. The transition probability at time infinity can be found by calculating the limiting distribution of the graph.

In step 125, one or more of the edges that were removed for embedding in the graph representation are selected, by the computer processor, based at least partly upon the traversal probability for each of the edges. According to an embodiment, the edges with the highest traversal probability are selected.

In step 130, information relating to the one or more edges is embedded into the graph representation. The information can be embedded in a metadata file associated with the graph at a particular level, or using any other suitable means.

The merged vertices introduce a level of hierarchy over the original vertices. Steps 105-130 are advantageously performed in several iterations thus providing several levels of hierarchy.

When several levels of hierarchy are present, the edges are embedded at the highest possible level. The selection of edges to be embedded is performed from the highest level to the lowest level of the hierarchy, and edges that are not selected are moved to a lower level of the hierarchy until no further valid levels remain.

According to a certain embodiment, only a limited number of edges with the highest traversal probability are attached to a given vertex in the graph, the remaining edges are pushed down to the next level in the graph.

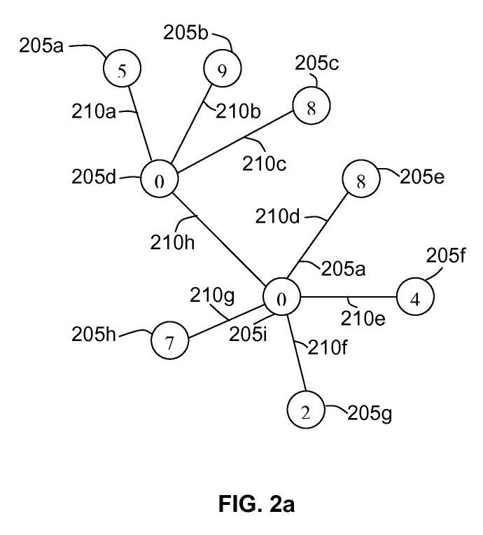

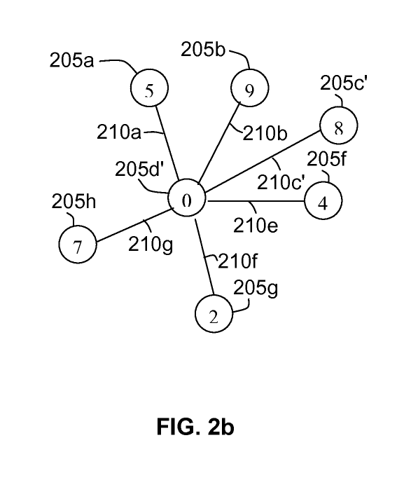

FIG. 2a and FIG. 2b illustrate an example of clustering and merging vertices, according to the method 100 of FIG. 1.

FIG. 2a illustrates a graph including a plurality of vertices 205a-i and a plurality of edges 210a-g, wherein each vertex 205a-i is assigned a cluster identifier. The cluster identifiers are represented in FIGS. 2a and 2b as integers, but any suitable identifier can be used. Vertex 205d and vertex 205i share a common cluster identifier, namely ‘0’, as does vertex 205c and vertex 205e, namely ‘8’.

FIG. 2b illustrates a graph corresponding to the graph of FIG. 2a after merging vertices and edges. Original vertices 205c and 205e are replaced with merged vertex 205c′. Original vertices 205d and 205i are replaced with merged vertex 205d′.

Edge 210h of FIG. 2a has been removed as it joined vertices 205d and 205i that are now part of merged vertex 205d′. Edges 210c and 210d are duplicate edges joining the same merged vertices 205c′ and 205d′, are removed and replaced by new edge 210c′.

In the case where duplicate edges are replaced by a merged edge, the merged edge has a weight assigned as the sum of the weights of the duplicate edges.

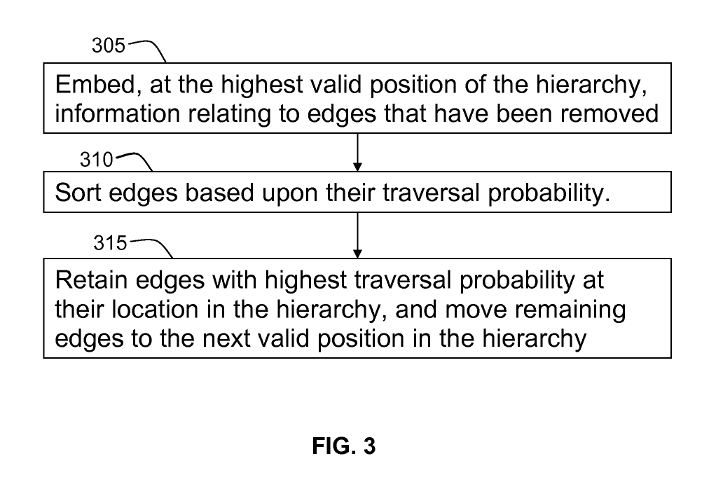

FIG. 3 illustrates a method 300 of selecting edges for embedding in the graph representation, according to an embodiment of the present invention.

As edges can be removed and added to the graph at different levels of the hierarchy, it is necessary to keep a record of information relating to removed edges to enable reconstruction of the compressed graph.

The level at which an edge is first introduced into the graph is referred to as the creation level of the edge. All edges initially present in the graph are assigned a creation level of zero. As discussed further below, edges can be introduced into the graph to replace duplicate edges, and accordingly have a creation level of greater than zero.

The level at which the edge was removed from the graph is referred to as the subsumed level of the edge. Edges are removed from the graph if two vertices that describe the edge are merged together or if a new edge is created to summarize multiple individual edges, as discussed further below.

At step 305, information relating to edges that have been removed, for example from step 115 of FIG. 1, is embedded at the highest valid position of the edge in the hierarchy. The information can include the creation and subsumed levels of the removed edge, and the traversal probability of the edge. The highest valid position of the edge is the subsumed level of the edge. As discussed above, the hierarchy can comprise a single level, or if clustering is performed in several iterations, multiple levels.

At step 310, edges are sorted based upon their traversal probability. In the case that an edge replaces several duplicate edges, for example, the traversal probability of the edge corresponds to the accumulated traversal probability of the replaced edges.

At step 315, the weighted edges with the lowest traversal probability are moved to a lower position in the hierarchy. This can be performed by allowing only a limited number of edges at each position in the hierarchy, for example, wherein any edges in excess of the limited number of edges are moved to a lower position in the hierarchy. The maximum number of edges can be variable for each clustered vertex. The maximum number of edges can vary depending upon the level and traversal probability of individual embedded edges at each clustered vertex for instance.

Edges that are created during the clustering process are only valid above their creation level in the hierarchy. Accordingly, edges are not moved to a lower level in the hierarchy than their creation level but are instead deleted.

According to an embodiment, the edges and vertices that belong to the same cluster are stored together on memory. This enables efficient memory access.

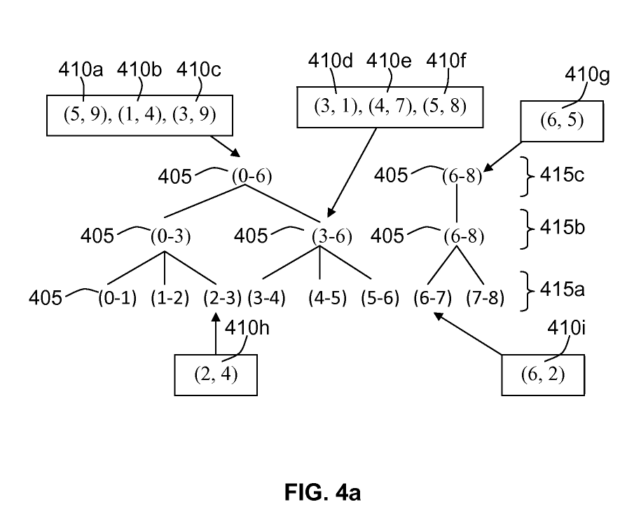

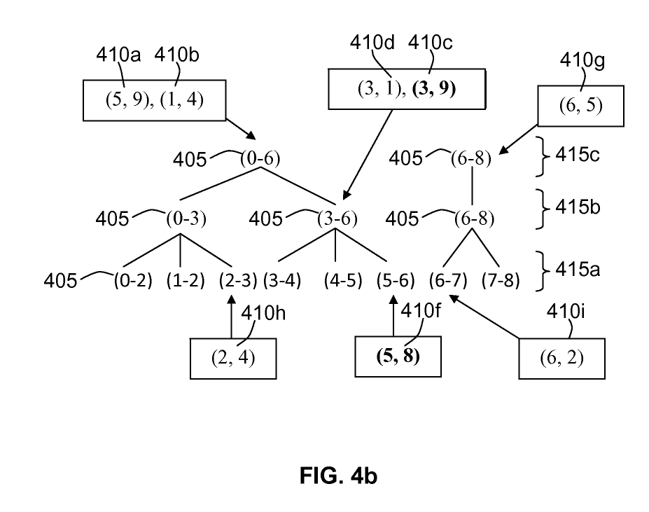

FIG. 4a and FIG. 4b illustrate an example of selecting edges for embedding in the graph representation, according to the method 300 of selecting edges for embedding in the graph representation.

FIG. 4a illustrates a first hierarchy 400a, including a plurality of cluster IDs 405, and a plurality of edges 410a-i. The edges 410a-i are embedded at their highest possible location in the hierarchy.

FIG. 4b illustrates a second hierarchy 400b, which is a compressed version of first hierarchy 400a. Two edges are allowed at each level 415a-c.

Edges 410a-i have been sorted according to their traversal probability, as shown in Table 1, below.

TABLE 1

| | Summary | Summary Link | | |
|---|---|---|---|---|
| | Link (src, | Edge Weight | | Creation |
| Edge label | dst) | (Rank) | Merged Level | Level |
| 410a | (5, 9) | 1 | 415c | 415a |
| 410d | (3, 1) | 2 | 415b | 415a |
| 410h | (2, 4) | 3 | 415a | 415a |
| 410b | (1, 4) | 4 | 415c | 415b |
| 410g | (6, 5) | 5 | 415c | 415a |
| 410i | (6, 2) | 6 | 415a | 415a |
| 410c | (3, 9) | 7 | 415c | 415a |
| 410e | (4, 7) | 8 | 415b | 415b |
| 410f | (5, 8) | 9 | 415b | 415a |

As only two edges can be embedded per level, a number of edges have been demoted to lower positions in the hierarchy. Starting from level 415c, the highest level of the graph, the edges with the highest traversal probability are selected to remain at their current position, and the remaining edges are pushed down one level to their next appropriate position in the hierarchy, namely 415b. Edges cannot be pushed below their creation level as the edge is not valid below the point at which it was created, and instead such edges are deleted.

Edge 410c has been demoted from level 415c to level 415b as it has a lower traversal probability than edges 410a and 410b, and edge 410f has been demoted from level 415b to level 415a as it has a lower traversal probability than edges 410c and 410d.

Edge 410e has a lower traversal probability than edges 410c and 410d, but cannot be demoted to level 415a as it was created in level 1. Accordingly, edge 410e is deleted from the hierarchy.

According to an embodiment, the cluster IDs 405 include information relating to the vertices of the cluster. This information is efficiently represented as a range of vertex identifiers, such as 0-6 or 0-3. In the context of FIGS. 4a and 4b, it can easily be determined from this information that vertex 1 is part of vertex 0-3 at a first compression level, and part of vertex 0-6 at a second compression level. The use of range identifiers in the cluster IDs 405 requires, however, a potential renumbering of vertices during clustering.

According to an alternative embodiment, each vertex includes information relating to the hierarchy to which it belongs. This enables compression and decompression of the hierarchy without renumbering of vertices. As will be understood by a person skilled in the art, any representation of vertex identification and location can be used without departing from the present invention.

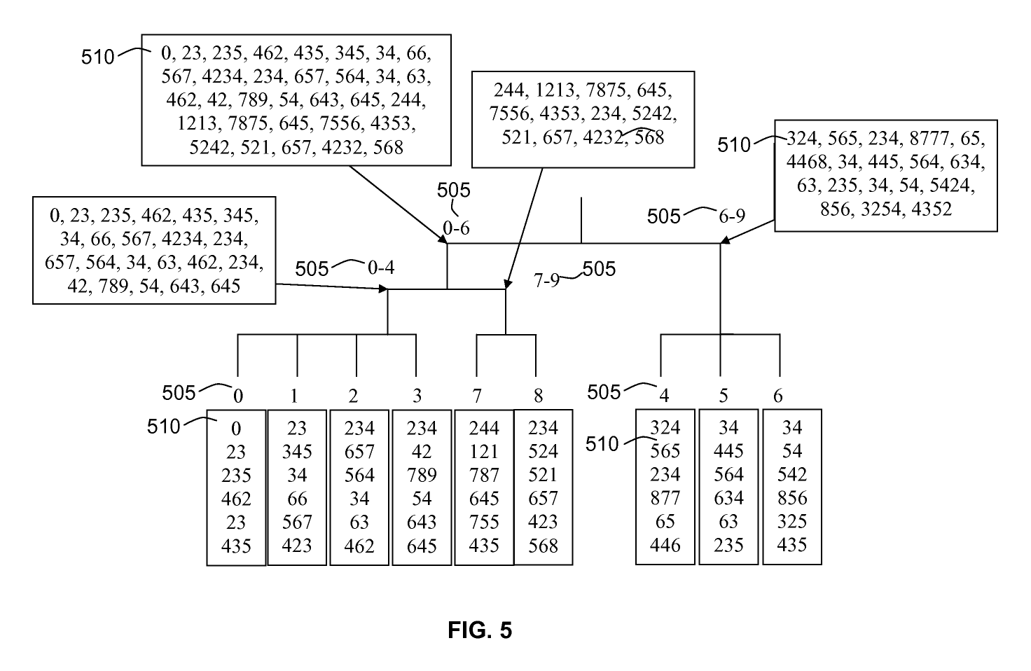

FIG. 5 illustrates a hierarchy 500 including storage of keywords, according to an embodiment of the present invention.

The hierarchy includes a plurality of nodes 505, and each node 505 is associated with a plurality of keywords 510. Each keyword 510 is represented as an integer.

The keyword 510 set at each node 505 comprises at least some of the keywords 510 appearing in the child nodes 505. According to certain embodiments, only the keywords 510 that are most important are stored at each node 505. This is advantageous as listing all keywords 510 of all the child nodes 505 can result in a very large number of keywords 510. Keywords 510 can be ranked by the number of times that a keyword 510 appears in the documents, by relevance or importance of the keyword 510, or by any other suitable means.

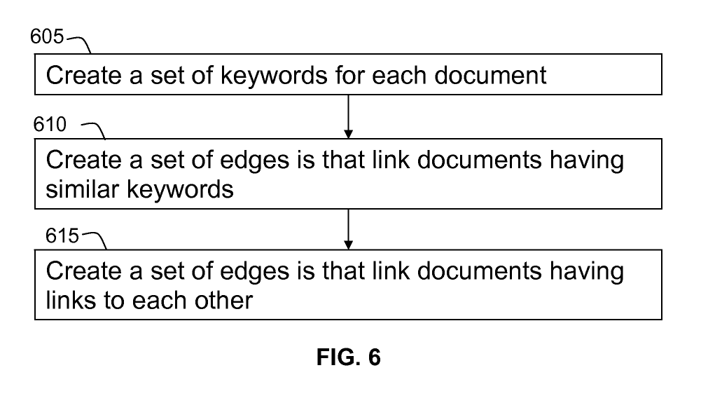

FIG. 6 illustrates a method 600 of building a graph, according to an embodiment of the present invention. The method 600 is described in the context of documents and keywords, but a skilled reader will readily adapt these teachings to apply to other data types and characteristics. Each document corresponds to a vertex in the graph.

At step 605, a set of keywords is created for each document. Any keyword generation algorithm may be used.

At step 610, a set of edges is created that links documents having similar keywords. This can be performed by linking documents that have at least a fixed number of keywords in common with one another.

At step 615, a set of edges is created that link documents having links to each other. An example of a link is a hyperlink in a first document referencing a second document. In this case an edge will be created between the first and second documents.

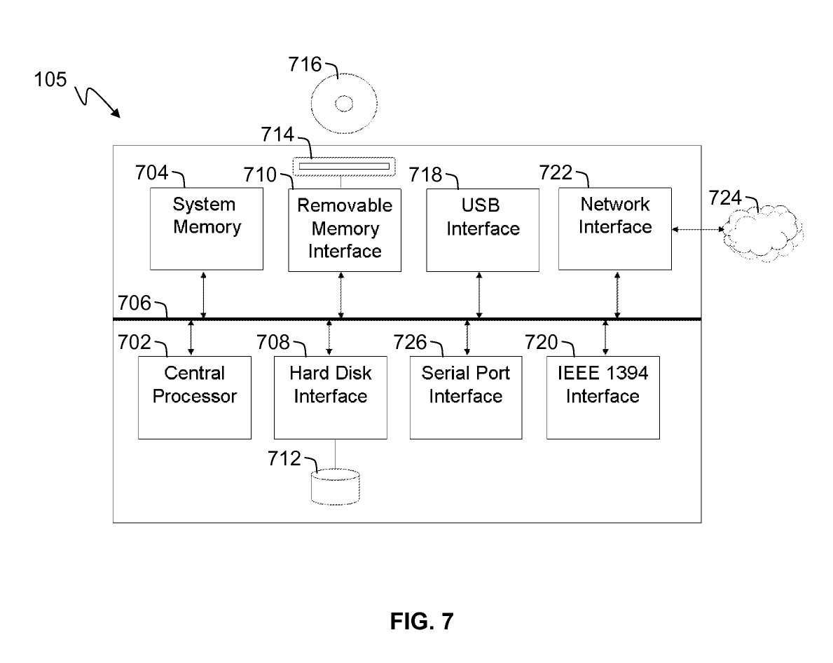

FIG. 7 diagrammatically illustrates a server 105, according to an embodiment of the present invention. The server 105 is particularly suited for performing the methods 100, 300, 600 described above.

The server 105 includes a central processor 702, a system memory 704 and a system bus 706 that couples various system components, including coupling the system memory 704 to the central processor 702. The system bus 706 may be any of several types of bus structures including a memory bus or memory controller, a peripheral bus, and a local bus using any of a variety of bus architectures. The structure of system memory 704 is well known to those skilled in the art and may include a basic input/output system (BIOS) stored in a read only memory (ROM) and one or more program modules such as operating systems, application programs and program data stored in random access memory (RAM).

The server 105 may also include a variety of interface units and drives for reading and writing data. In particular, the server 105 includes a hard disk interface 708 and a removable memory interface 710, respectively coupling a hard disk drive 712 and a removable memory drive 714 to the system bus 706. Examples of removable memory drives 714 include magnetic disk drives and optical disk drives. The drives and their associated computer-readable media, such as a Digital Versatile Disc (DVD) 716 provide non-volatile storage of computer readable instructions, data structures, program modules and other data for the server 105. A single hard disk drive 712 and a single removable memory drive 714 are shown for illustration purposes only and with the understanding that the server 105 may include several similar drives. Furthermore, the server 105 may include drives for interfacing with other types of computer readable media.

The server 105 may include additional interfaces for connecting devices to the system bus 706. FIG. 7 shows a universal serial bus (USB) interface 718 which may be used to couple a device to the system bus 706. For example, an IEEE 1394 interface 720 may be used to couple additional devices to the server 105.

The server 105 can operate in a networked environment using logical connections to one or more remote computers or other devices, such as a server, a router, a network personal computer, a peer device or other common network node, a wireless telephone or wireless personal digital assistant. The server 105 includes a network interface 722 that couples the system bus 706 to a local area network (LAN) 724. Networking environments are commonplace in offices, enterprise-wide computer networks and home computer systems.

A wide area network (WAN), such as the Internet, can also be accessed by the server 105, for example via a modem unit connected to a serial port interface 726 or via the LAN 724.

It will be appreciated that the network connections shown and described are exemplary and other ways of establishing a communications link between computers can be used. The existence of any of various well-known protocols, such as TCP/IP, Frame Relay, Ethernet, FTP, HTTP and the like, is presumed, and the server 105 can be operated in a client-server configuration to permit a user to retrieve web pages from a web-based server. Furthermore, any of various conventional web browsers can be used to display and manipulate data on web pages.

The operation of the server 105 can be controlled by a variety of different program modules. Examples of program modules are routines, programs, objects, components, and data structures that perform particular tasks or implement particular abstract data types. The present invention may also be practiced with other computer system configurations, including hand-held devices, multiprocessor systems, microprocessor-based or programmable consumer electronics, network PCs, minicomputers, mainframe computers, personal digital assistants and the like. Furthermore, the invention may also be practiced in distributed computing environments where tasks are performed by remote processing devices that are linked through a communications network. In a distributed computing environment, program modules may be located in both local and remote memory storage devices.

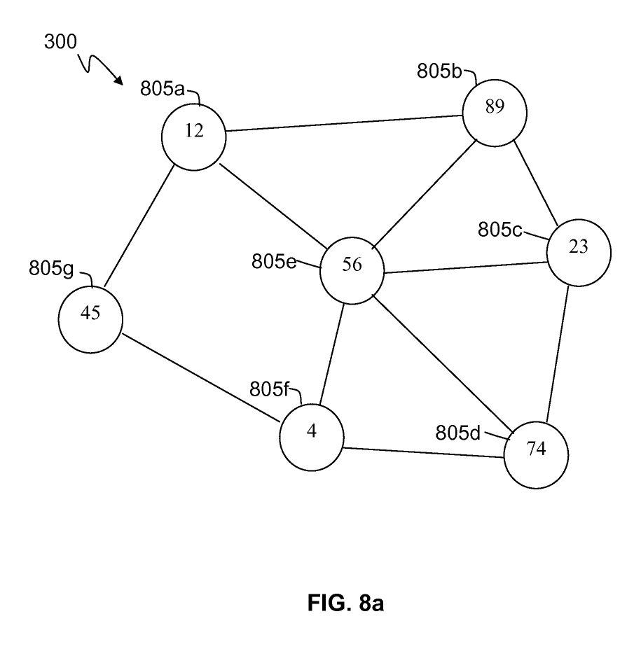

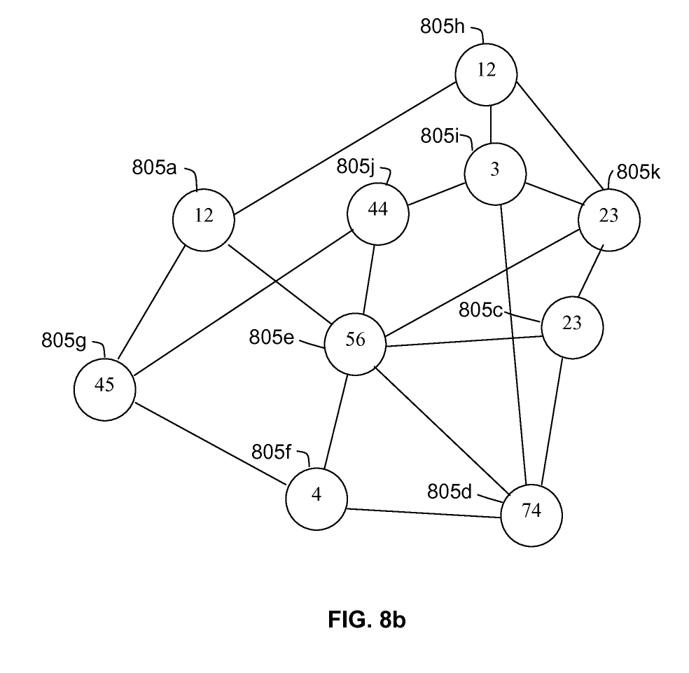

FIG. 8a and FIG. 8b illustrate an example of processing a search query, according to an embodiment of the present invention. FIG. 8a illustrates a compressed graph 800a, and FIG. 8b illustrates an expanded graph 800b. As will be understood by a person skilled in the art, the graph may be compressed (and therefore expanded) in many layers.

Each vertex 805a-g is assigned a score based upon the number of documents grouped under that vertex and a keyword match with the search query. The score corresponds to an expected utility associated with the vertex for the search query.

The vertex 805a-g (or several vertices 805a-g) with the highest score are then expanded. Vertex 805b of FIG. 8a is expanded and replaced by vertices 805h-k in FIG. 8b.

Each new vertex 805h-k is assigned a new score and the procedure can be repeated.

Due to time limitations when decompressing the graph, it is desirable to limit the number of vertices that can be expanded.

According to an embodiment, one or more documents are embedded at each level of the hierarchy. Upon decompression, the one or more documents at each level are made available to the search.

Firstly, an expected utility is calculated for each vertex that has been expanded. The expected utility can be identical to or similar to the score described above, and can be based upon the number of documents embedded in the vertex and the keyword match score. The keyword match score for a given vertex is derived from the precompiled keyword sets embedded at each compressed vertex. A vertex with keywords that appear frequently across all vertices is given a high keyword match score. Each document embedded in a vertex is assigned the expected utility of the vertex.

A keyword score is calculated for each document that has been made available to the search. A dictionary of keywords with strong relevance to the query is generated, which can be generated based upon a precompiled set of keywords of each document, for example the plurality of keywords 510 of FIG. 5. The number of keyword sets extracted from each vertex is advantageously proportional to the expected utility of that vertex in order to give a greater weight to keywords appearing in vertices with a high expected utility. The keyword score for each document can then be calculated using an inverted index, for example, or any other suitable means.

The ranking of the documents is then based upon both the keyword score of the document and the expected utility of the document.

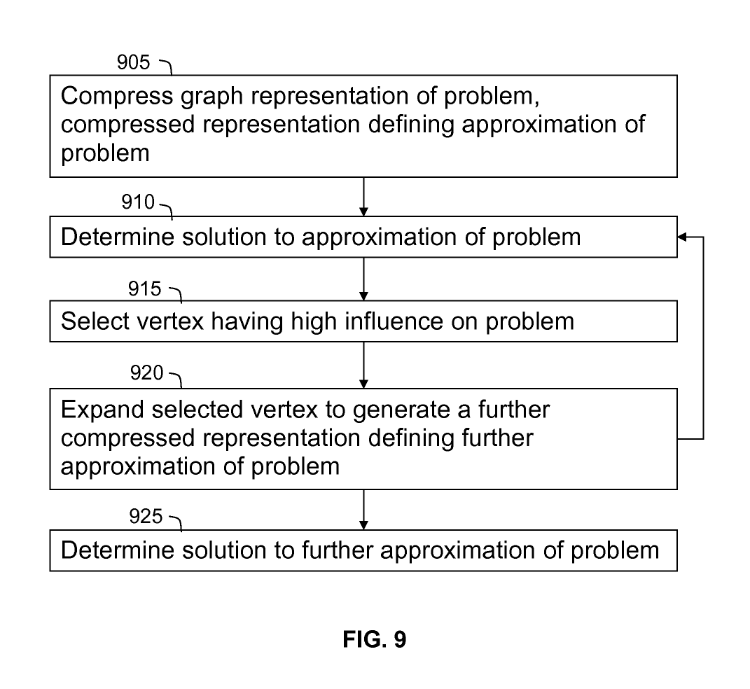

FIG. 9 illustrates a method 900 of solving a problem according to an embodiment of the present invention.

As discussed above, many different types of problems exist that can be represented using graphs. Graph compression can be used to define a constrained optimization of such problems, and thus find a solution to such problems, as described in further detail below.

In step 905, a graph representation of the problem is compressed. The graph representation can be compressed using the methods described earlier, and advantageously using a compression function appropriate to the specific optimization problem. For example, the traversal probabilities can be calculated according to the optimization problem. The resulting compressed graph defines a first approximation of the problem.

In step 910, a solution corresponding to the first approximation of the problem is determined. The solution can be determined by assigning a value to each decision variable represented by a compressed vertex.

Summary data such as traversal probability and expected utility can be included in the compressed graph in order to assist in determining a solution to the first approximation of the problem.

In step 915, a clustered vertex is selected that appears to have a high influence on the optimization problem. The clustered vertex can be selected according to traversal probability and/or expected utility, for example.

In step 920, the selected clustered vertex is expanded into a corresponding cluster of vertices to generate a second clustered graph.

The second clustered graph defines a second approximation of the problem. The second approximation is typically a better approximation of the problem than the first approximation.

In step 925, a solution to the second approximation of the problem is determined using the second clustered graph. The solution to the second approximation can comprise a refinement of the solution to the second optimization.

The solution to the second approximation of the problem can be generated using values assigned in the parent problem, e.g. the first approximation of the problem. In this case, a local optimization can take place including only the new vertices, i.e. vertices expanded from the selected clustered vertex, wherein the vertices considered in the parent optimization are given static values of the parent problem.

Steps 915 to 925 can then be repeated, and thus the solution to the problem can be refined sequentially. As will be readily understood by the skilled addressee, steps 910 and 915 can be performed a predetermined number of times, or until a threshold is met, for example. Typically a lower level of granularity provides a more optimal solution.

According to certain embodiments, the graph is compressed and decompressed several times, each time further information from a previous optimization can be used to improve the solution.

According to certain embodiment, the problem relates to generating an optimal or near optimal plan under uncertainty. In many industries such as the mining and finance industry, plans need to be constructed under a great level of uncertainty. Such plans can be described as stochastic programs which can be represented by stochastic trees. Uncertainty is often represented as scenarios which represent a possible future outcome, each future outcome with an associated probability. A plan must therefore be constructed that takes into account multiple future scenarios so as to maximize a net expected return of the project under different levels of uncertainty.

A scenario tree can encapsulate all possible plans to be considered. In practice, scenario trees are generated through simulation. As the number of variables in the problem grows linearly, the scenario tree grows exponentially in size. In many cases, however, the full scenario tree cannot be represented entirely in memory even for modest sized problems. As such it is often necessary to limit the expansion of the scenario tree whilst not sacrificing accuracy and/or optimality of the solution.

Graph compression according to the present invention and as described above, can be used to optimize a compressed version of a scenario tree. In such cases, scenarios can be aggregated together based on some similarity measure such as Euclidian distance. Upon optimizing the compressed version of the scenario tree (represented as a compressed graph), the graph can be expanded by the addition of states and scenarios to the current plan in regions under which optimality of a compressed vertex is considered high.

Additional states and scenarios can be added to the scenario tree, as new state information is added. New edge or state information can be generated dynamically and can account for information not originally present when the graph was compressed.

As such it may be desirable to undergo decompression followed by recompression to incorporate the newly generated state information. Following the recompression, the optimal plan in the compressed state can once again be derived and later expanded. This compression/decompression cycle can be repeated an arbitrary number of times until the uncompressed scenario tree is of a desired size. An optimal or near optimal plan can then be derived from the uncompressed scenario tree.

In some cases it may be desirable to only recompress the graph to a point after a decompression takes place. This may be possible for instance if the compressed graph matches a previously compressed version of the graph and the previous optimal values assigned to each compressed vertex can be reused. Hence it is not always necessary to fully recompress the graph.

In summary, advantages of some embodiments of the present invention include an ability to build a compressed graph encompassing the vertices of interest while excluding vertices that have little or no value. The amount of data that need to be transferred from external storage, for example, in order to execute the query is reduced, it is possible to include all available information when processing the query, and varying levels of granularity can be used to describe a large graph at different levels of detail. The reduced representation of the graph, e.g. the coarse levels of granularity, can be used to approximate the transition probabilities between a subset of nodes in the graph.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1. A method of compressing a graph representation, the graph representation including a plurality of vertices and a plurality of edges, the method comprising:
generating, by a computer processor, a first clustered graph by clustering the plurality of vertices of the graph representation, replacing each cluster of vertices with a clustered vertex, wherein the clustered vertex inherits edges from the vertices of the cluster, and removing superfluous edges of the first clustered graph;
determining, by the computer processor, a traversal probability for each of the edges that have been removed from the graph representation;
selecting, by the computer processor, one or more of the edges that have been removed for embedding in the first clustered graph, based upon the traversal probability for each of the edges; and
embedding, by the computer processor, information relating to the one or more edges into the first clustered graph.

2. The method of claim 1, wherein the superfluous edges comprise edges that either join vertices of a single cluster or are duplicate edges joining a common pair of clustered vertices.

3. The method of claim 1, wherein the vertices of the graph representation each correspond to a document.

4. The method of claim 3, wherein the traversal probabilities are determined according to a number of matching keywords between two documents.

5. The method of claim 1, wherein the vertices of the graph representation each correspond to a file or a part of a file

6. The method of claim 5, wherein the file corresponds to an image file, an audio and/or a video file.

7. The method of claim 1, wherein the clustering is performed based at least partly upon traversal probabilities between the plurality of vertices.

8. The method of claim 1, wherein the traversal probabilities are determined by estimating a limiting distribution of the graph.

9. The method of claim 1, wherein the edges that are selected for embedding in the first clustered graph are selected by having the highest traversal probability.

10. The method of claim 1, wherein embedding information of the one or more edges into the first clustered graph comprises generating a metadata file associated with the first clustered graph.

11. The method of claim 1, further comprising:
generating, by a computer processor, a second clustered graph by clustering the clustered vertices of the first clustered graph, replacing each cluster of clustered vertices with a further clustered vertex, wherein the further cluster vertex inherits edges from the clustered vertices of the cluster, and removing superfluous edges of the second clustered graph;
determining, by the computer processor, a traversal probability for each of the edges that have been removed from the first clustered graph;
selecting, by the computer processor, one or more of the edges that have been removed from the first clustered graph for embedding in the second clustered graph, based upon the traversal probability for each of the edges; and
embedding, by the computer processor, information relating to the one or more edges into the second clustered graph.

12. The method of claim 1, further comprising:
selecting, by the computer processor, one or more of the edges that have been removed from the first clustered graph for embedding in the first clustered graph, based upon the traversal probability for each of the edges; and
embedding, by the computer processor, information relating to the one or more edges into the first clustered graph.

13. The method of claim 3, further comprising:
generating, by the computer processor, a set of keywords for each document of the graph representation;
generating, by the computer processor, a first plurality of edges between documents of the graph representation, wherein each edge of the first plurality of edges is between two documents that include similar keyword sets; and
generating, by the computer processor, a second plurality of edges between documents of the plurality of documents, wherein each edge of the second plurality of edges is between a first and second document, wherein the first document includes a link to the second document.

14. A method of solving a problem associated with a graph representation, the graph representation including a plurality of vertices and a plurality of edges, the method comprising:
generating, by a computer processor, a first clustered graph by clustering the plurality of vertices of the graph representation, replacing each cluster of vertices with a clustered vertex, wherein the clustered vertex inherits edges from the vertices of the cluster, and removing edges that either join vertices of a single cluster or are duplicate edges joining the same clustered vertex, the first clustered graph defining a first approximation of the problem;
determining, by the computer processor, a traversal probability for each of the edges that have been removed from the graph representation;
selecting, by the computer processor, one or more of the edges that have been removed for embedding in the first clustered graph, based upon the traversal probability for each of the edges; and
embedding, by the computer processor, information relating to the one or more edges into the first clustered graph;
determining a solution to the first approximation of the problem using the first clustered graph;
expanding at least one clustered vertex into a corresponding cluster of vertices to generate a second clustered graph, the second clustered graph defining a second approximation of the problem; and
determining a solution to the second approximation of the problem using the second clustered graph and the solution to the first approximation of the problem.

15. A method of solving a problem associated with a graph representation including:
generating, by a computer processor, a first clustered graph, the first clustered graph representing an approximation of the problem;
determining, by the computer processor, a solution corresponding to the first approximation of the problem using the first clustered graph;
selecting, by the computer processor, a clustered vertex that appears to have a high influence on the optimization problem;
expanding, by the processor, the selected clustered vertex into a corresponding cluster of vertices to generate a second clustered graph, the second clustered graph representing a second approximation of the problem; and
determining, by the processor, a solution to the second approximation of the problem using the second clustered graph and the solution to the first approximation of the problem.
